(19) United States
(12) Patent Application Publication
(10) Pub. No.: US 2004/0134599 A1
(43) Pub. Date: Jul. 15, 2004

(54) Over-current protection device and manufacturing method thereof

(75) Inventors: David Shau-Chew Wang, Taipei (TW); Yun-Ching Ma, Pingtung (TW); Edward F. Chu, Taipei (TW)

Correspondence Address: Janah & Associates, P.C., Suite 106, 650 Delancey Street, San Francisco, CA, 94107, US

(73) Assignee: Polytronics Technology Corporation

(21) Appl. No.: 10/742,263

(22) Filed: Dec. 18, 2003

(30) Foreign Application Priority Data
Jan. 8, 2003 (TW) 092100374

(51) Int. Cl. H02H 7/00; B29C 47/00; B32B 31/00

(52) U.S. Cl. 156/244.27; 156/272.2; 361/18

(57) ABSTRACT

An over-current protection device and manufacturing method thereof are revealed. The method for manufacturing an over-current protection device comprises the steps of: (1) providing at least two polymer current-sensing elements, the at least two polymer current-sensing elements comprise flame retardant, and the switching temperatures of adjacent polymer current-sensing elements differ from each other by at least 5° C.; (2) irradiating the at least two polymer current-sensing elements; (3) annealing the at least two polymer current-sensing elements; and (4) combining a first electrode foil and a second electrode foil with the at least two polymer current-sensing elements as a laminate. The at least two polymer current-sensing elements can be irradiated of less than 50 Mrads by Cobalt 60, and be annealed 6-20 hours with a temperature between 100-120° C. Moreover, the flame retardant may be composed of magnesium hydroxide or talc.

### BACKGROUND OF THE INVENTION

(A) Field of the Invention

The present invention is related to an over-current protection device and manufacturing method thereof, more specifically, to an over-current protection device with high voltage endurance and manufacturing method thereof.

(B) Description of Related Art

For the present broad application of portable electronic products, such as mobile phone, notebook, portable camera, personal digital assistant (PDA), etc., the use of over-current protection devices to prevent the short circuit caused by an over-current or over-heating effect in a secondary battery or circuit device is becoming more and more important.

The resistance of a positive temperature coefficient (PTC) conductive material is sensitive to temperature variation, and can be kept extremely low at normal operation due to its low sensitivity to temperature variation so that the circuit can operate normally. However, if an over-current or an over-temperature event occurs, the resistance will immediately increase to a high resistance state (e.g., above 10⁴ ohm.) Therefore, the over-current will be reversely eliminated and the objective to protect the circuit device can be achieved.

Patent U.S. Pat. No. 4,924,047 discloses a laminate of three PTC elements to improve the adherence between the PTC elements and their electrodes, in which the PTC element is irradiated of more than 50 million roentgen-absorbed doses (Mrads) to endure high voltage. Although such laminate can somewhat diminish the voids between the PTC elements and the electrodes, considerable gas may be generated or the PTC elements may be destroyed by the jumping temperature due to high irradiation doses. Moreover, US patents such as U.S. Pat. No. 5,303,115, U.S. Pat. No. 5,227,946, U.S. Pat. No. 5,195,013, U.S. Pat. No. 5,140,297, U.S. Pat. No. 4,955,267, U.S. Pat. No. 4,951,384, U.S. Pat. No. 4,951,382, U.S. Pat. No. 4,907,340, U.S. Pat. No. 4,857,880, U.S. Pat. No. 4,845,838 and U.S. Pat. No. 4,475,138 also disclose relevant technologies of PTC devices, but they still cannot effectively solve the problems during the manufacturing of high voltage PTC devices.

### SUMMARY OF THE INVENTION

The major object of the invention is to provide an over-current protection device with high voltage endurance, specifically high than 250 volts, and manufacturing method thereof, using less irradiation doses and adding flame retardant to prevent the PTC device from being damaged due to high temperature.

The method of manufacturing an over-current protection device in accordance with the present invention comprises the steps of: (1) providing at least two polymer current-sensing elements, the at least two polymer current-sensing elements comprise flame retardant, and the switching temperatures of adjacent polymer current-sensing elements differ from each other by at least 5° C.; (2) irradiating the at least two polymer current-sensing elements; (3) annealing the at least two polymer current-sensing elements; and (4) combining a first electrode foil and a second electrode foil with the at least two polymer current-sensing elements as a laminate. The flame retardant can be composed of inert materials such as magnesium hydroxide or talc. The at least two polymer current-sensing elements can be irradiated by Cobalt 60 with less than 50 Mrads, and then be annealed 6-20 hours with a temperature of 100-120° C. The polymer current-sensing elements can be irradiated with different doses, and then they are combined to be irradiated once more.

The over-current protection device of the present invention comprises a first electrode foil, at least two laminated polymer current-sensing elements and a second electrode foil, where the first electrode foil connected to one side of the at least two laminated polymer current-sensing elements, and the second electrode foil connected to the other side of the at least two laminated polymer current-sensing elements. The at least two laminated polymer current-sensing elements including flame retardant, and the switching temperatures of adjacent polymer current-sensing elements differ from each other by at least 5° C. The at least two polymer current-sensing elements can be irradiated of less than 50 Mrads by Cobalt 60, and be annealed 6-20 hours with a temperature of 100-120° C. Moreover, the flame retardant may be composed of magnesium hydroxide or talc.

### BRIEF DESCRIPTION OF THE DRAWINGS

The present invention will be described according to the appended drawings in which:

FIG. 1 illustrates an over-current protection device in accordance with the present invention; and

FIG. 2 illustrates an over-current protection device of plug-in type in accordance with the present invention.

### DESCRIPTION OF PREFERRED EMBODIMENTS

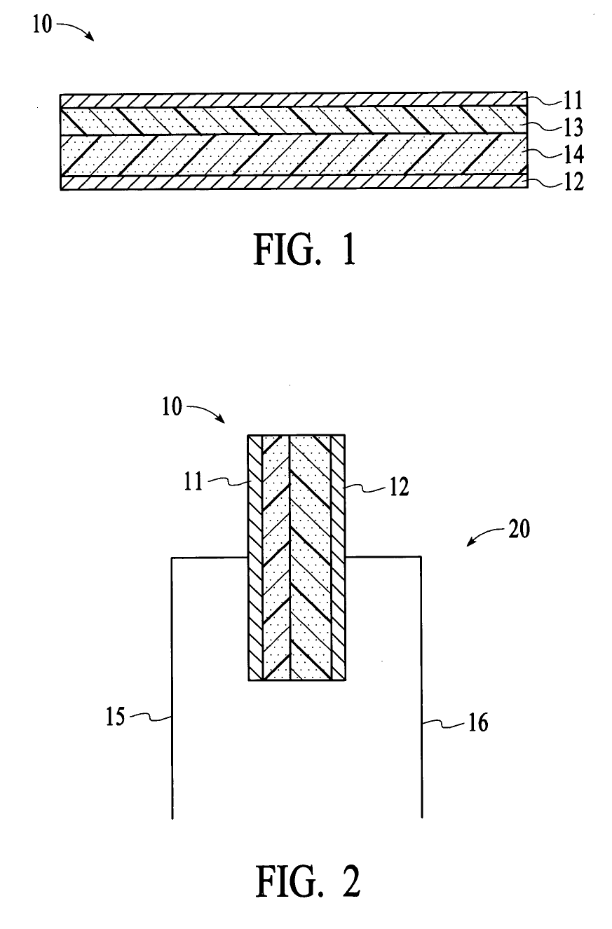

FIG. 1 illustrates an over-current protection device 10 including a first electrode foil 11, a first polymer current-sensing element 13, a second polymer current-sensing element 14 and a second electrode foil 12. The first and second polymer current-sensing elements 13, 14 include polymer, carbon blacks, inorganic fillers and additives. The switching temperatures of the first polymer current-sensing element 13 and the second polymer current-sensing element 14 differ from each other by at least 5° C. The inorganic fillers may include inert materials such as magnesium hydroxide or talc to be flame retardant. Talc is a known engineering material, and it also has the feature of flame retardant due to the contained inert materials such as magnesium oxide and silicon oxide.

The first current-sensing element 13 and the second current-sensing element 14 are both irradiated of less than 50 Mrads to cross-link the ingredients of the first current-sensing element 13 and the second current-sensing element 14. In addition, the first current-sensing element 13 and the second current-sensing element 14 are annealed in a temperature less than the melting point. If the melting points of the first current-sensing element 13 and the second current-sensing element 14 are approximately 125° C., the first current-sensing element 13 and the second current-sensing element 14 can be annealed 6-20 hours with a temperature between 100-120° C.

By virtue of the annealing and different switching temperatures of polymer current-sensing elements, the over-current protection device of the present invention does not need to be exposed with high irradiation doses to meet the requirement of high voltage endurance. As a result, the high temperature damage and the voids generated by gas due to the high irradiation doses can be significant diminished. Because the apprehension of void formation can be ignored, the first polymer current-sensing element 13 and the second polymer current-sensing element 14 can be combined with the first electrode foil 11 and the second electrode foil 12 before or after irradiation, and the irradiation and the annealing may be performed simultaneously. Therefore, the flexibility of the process is increased significantly.

In practice, the over-current protection device of the present invention is not limited to possess two polymer current-sensing elements, an over-current protection device of three or more polymer current-sensing elements can also be implemented in accordance with the present invention.

As shown in FIG. 2, the first electrode foil 11 and the second electrode foil 12 can be respectively soldered with leads 15 and 16 to form an over-current protection device of plug-in type for being connected to a device needed to be protected.

The above-described embodiments of the present invention are intended to be illustrative only. Numerous alternative embodiments may be devised by those skilled in the art without departing from the scope of the following claims.

What is claimed is:

1. A method for manufacturing an over-current protection device, comprising the steps of:
providing at least two polymer current-sensing elements, wherein the at least two polymer current-sensing elements comprise flame retardant, and the switching temperatures of adjacent polymer current-sensing elements differ from each other by at least 5° C.;
irradiating the at least two polymer current-sensing elements;
annealing the at least two polymer current-sensing elements; and
combining a first electrode foil and a second electrode foil with the at least two polymer current-sensing elements as a laminate.

2. The method for manufacturing an over-current protection device of claim 1, wherein the at least two polymer current-sensing elements are irradiated of less than 50 Mrads.

3. The method for manufacturing an over-current protection device of claim 1, wherein the at least two polymer current-sensing elements are irradiated by Cobalt 60.

4. The method for manufacturing an over-current protection device of claim 1, wherein the flame retardant comprises one of magnesium hydroxide and talc.

5. The method for manufacturing an over-current protection device of claim 1, wherein the at least two polymer current-sensing elements are annealed in a temperature range of 100° C. to 120° C.

6. The method for manufacturing an over-current protection device of claim 5, wherein the at least two polymer current-sensing elements are annealed in a time range of 6 to 20 hours.

7. An over-current protection device, comprising:
at least two laminated polymer current-sensing elements including flame retardant, and the switching temperatures of adjacent polymer current-sensing elements being different from each other by at least 5° C.;
a first electrode foil connected to one side of the at least two laminated polymer current-sensing elements; and
a second electrode foil connected to the other side of the at least two laminated polymer current-sensing elements.

8. The over-current protection device of claim 7, wherein the at least two laminated polymer current-sensing elements are irradiated of less than 50 Mrads.

9. The over-current protection device of claim 7, wherein each of the at least two laminated polymer current-sensing elements is irradiated with different dose.

10. The over-current protection device of claim 7, wherein the at least two polymer current-sensing elements are annealed in a temperature range of 100° C. to 120° C.

11. The over-current protection device of claim 7, wherein the flame retardant comprises one of magnesium hydroxide and talc.
